(19) United States
(12) Patent Application Publication
(10) Pub. No.: US 2024/0005355 A1
(43) Pub. Date: Jan. 4, 2024

(54) PLACEMENT OF ADVERTISEMENTS IN PLAYBACK

(71) Applicant: International Business Machines Corporation, Armonk, NY (US)

(72) Inventors: Sani Patel, Brampton (CA); Lior Aronovich, Thornhill (CA)

(21) Appl. No.: 17/809,648

(22) Filed: Jun. 29, 2022

(51) Int. Cl. G06Q 30/02

(52) U.S. Cl. CPC G06Q 30/0244; G06Q 30/0201; G06Q 30/0272

(57) ABSTRACT

In an approach for selectively placing an advertisement in a media item to maximize user engagement, a processor analyzes the media item by performing a static and dynamic scan. A processor determines whether it is more likely the user will engage with an advertisement placed in a foreground section or a background section of the media item. Responsive to determining it is more likely the user engages with the advertisement placed in the foreground section of the media item, a processor loads a set of time intervals associated with the peak regions of the media item. Responsive to determining the level of engagement by the user with the potential advertisement exceeds the threshold when the potential advertisement is associated with the media item, a processor associates the advertisement with the media item. A processor dynamically changes a background music of the advertisement with a sound extracted from the media item.

### BACKGROUND OF THE INVENTION

The present invention relates generally to the field of data processing, and more particularly to a placement of advertisements in playback.

Advertising is the techniques and practices used to bring products, services, opinions, or causes to public notice for the purpose of persuading the consumer to respond in a certain way toward what is advertised. An advertisement appears in a public medium, such as in a newspaper or a magazine, on a radio or a television, or on the internet. Most advertising involves promoting a good that is for sale, but similar methods are used to encourage people to drive safely, to support various charities, or to vote for political candidates, among many other examples.

### SUMMARY

Aspects of an embodiment of the present invention disclose a method, computer program product, and computer system for selectively placing one or more advertisements in a playback to maximize user engagement. Responsive to a user selecting a media item on a platform, a processor analyzes the media item by performing a static scan and a dynamic scan. A processor determines whether the user is engaging with the media item. Responsive to determining the user is not engaging with the media item, a processor determines whether it is more likely the user will engage with a potential advertisement placed in a foreground section of the media item or a background section of the media item based on one or more metrics gathered about the user. Responsive to determining it is more likely the user engages with the potential advertisement placed in the foreground section of the media item based on the one or more metrics gathered about the user, a processor loads a set of time intervals associated with one or more peak regions of the media item. A processor initiates a selection process of an advertisement. A processor determines whether a level of engagement by the user with the potential advertisement exceeds a threshold when the potential advertisement is associated with the media item. Responsive to determining the level of engagement by the user with the potential advertisement exceeds the threshold when the potential advertisement is associated with the media item, a processor associates the advertisement with the media item. A processor dynamically changes a background music of the advertisement with a sound extracted from the media item. A processor presents an updated advertisement in the media item to the user.

In some aspects of an embodiment of the present invention, a processor identifies whether there are any peak regions in the media item. A processor identifies whether there are any trough regions in the media item.

In some aspects of an embodiment of the present invention, subsequent to identifying whether there are the any trough regions in the media item, a processor divides the media item into two or more sections based on the any peak regions identified and the any trough regions identified using a Fourier transform. A processor determines a time interval of each section of the two or more sections. A processor associates a sound with each section of the two or more sections.

In some aspects of an embodiment of the present invention, a processor selects the advertisement based on one or more factors, wherein the one or more factors includes a maximum amount of time allowed for the advertisement and a popularity of the media item.

In some aspects of an embodiment of the present invention, responsive to determining the level of engagement by the user with the potential advertisement does not exceed the threshold when the potential advertisement is associated with the media item, a processor plays an original version of the advertisement.

In some aspects of an embodiment of the present invention, a processor determines whether there is music that can be associated with a first section of the two or more sections. Responsive to determining there is no music that can be associated with the first section of the two or more sections, a processor determines whether there is music that can be associated with the advertisement in the media item. Responsive to determining there is no music that can be associated with the advertisement in the media item, a processor determines if there is a first music preference of the user with which the user is more likely to engage. Responsive to determining there is no first music preference of the user with which the user is more likely to engage, a processor determines if there is a second music preference of the user that is trending. Responsive to determining the second music preference of the user is trending, a processor dynamically associates the second music preference with the advertisement.

In some aspects of an embodiment of the present invention, responsive to determining it is more likely the user engages with the potential advertisement placed in the background section of the media item based on the one or more metrics gathered about the user, a processor loads a set of time intervals associated with one or more trough regions of the media item. A processor initiates the selection process of the advertisement. A processor determines whether a level of engagement by the user with the potential advertisement exceeds the threshold when a volume of the potential advertisement is tuned and a narrator of the potential advertisement is selected. Responsive to determining the level of engagement by the user with the potential advertisement exceeds the threshold when the volume of the potential advertisement is tuned and the narrator of the potential advertisement is selected, a processor dynamically selects the narrator of the advertisement based on one or more components of the advertisement. A processor dynamically tunes the volume of the advertisement based on the one or more components of the advertisement. A processor presents the updated advertisement in the media item to the user.

In some aspects of an embodiment of the present invention, responsive to determining the level of engagement by the user with the advertisement does not exceed the threshold when the volume of the advertisement is tuned and the narrator of the advertisement is selected, a processor plays the original version of the advertisement.

In some aspects of an embodiment of the present invention, a processor assigns a degree of matching between each version of the narrator of the advertisement and each trough region of the one or more trough regions of the media item. Responsive to determining there is not a threshold degree of matching between a first version of the narrator of the advertisement and a first trough region of the one or more trough regions of the media item, a processor filters out the first version of the narrator of the advertisement. A processor selects a version of the narrator of the advertisement with a highest degree of matching using a Fast Fourier transform.

In some aspects of an embodiment of the present invention, subsequent to presenting the updated advertisement in the media item to the user, a processor determines whether the advertisement is within a maximum allowable time. Responsive to determining the advertisement is not within the maximum allowable time, a processor determines whether there are one or more other advertisements available. Responsive to determining there are no other advertisements available, a processor gathers a set of data points on a set of parameters to optimize a future updated advertisement.

These and other features and advantages of the present invention will be described in, or will become apparent to those of ordinary skill in the art in view of, the following detailed description of the example embodiments of the present invention.

### BRIEF DESCRIPTION OF THE DRAWINGS

FIG. 1 is a block diagram illustrating a distributed data processing environment, in accordance with an embodiment of the present invention;

FIG. 2 is a flowchart illustrating the operational steps of an advertisement placement program, on a server within the distributed data processing environment of FIG. 1, in accordance with an embodiment of the present invention;

FIG. 3 is a flowchart illustrating the operational steps of a change component of the advertisement placement program, on the server within the distributed data processing environment of FIG. 1, in accordance with an embodiment of the present invention;

FIG. 4 is a flowchart illustrating the operational steps of a selection component of the advertisement placement program, on the server within the distributed data processing environment of FIG. 1, in accordance with an embodiment of the present invention;

FIG. 5A is an exemplary diagram illustrating a platform where an audio playback is selected by a user to play, on the server within the distributed data processing environment of FIG. 1, in accordance with an embodiment of the present invention;

FIG. 5B is an exemplary diagram illustrating a platform where a video playback is selected by a user to play, on the server within the distributed data processing environment of FIG. 1, in accordance with an embodiment of the present invention;

FIG. 5C is an exemplary diagram illustrating a static scan and a dynamic scan working in tandem, on the server within the distributed data processing environment of FIG. 1, in accordance with an embodiment of the present invention; and

FIG. 6 is a block diagram illustrating the components of the server within the distributed data processing environment of FIG. 1, in accordance with an embodiment of the present invention.

### DETAILED DESCRIPTION

Embodiments of the present invention recognize that for an advertisement to be effective, its production and placement must be based on a knowledge of the consumer and a skilled use of the media. Advertising agencies serve to orchestrate complex campaigns whose strategies of media use are based on research into consumer behavior and demographic analysis of the market area. A strategy will combine creativity in the production of the advertising messages with canny scheduling and placement, so that the messages are seen by, and will influence, the people the advertiser most wants to address. Given a fixed budget, advertisers face a basic choice: they can have their message seen or heard by many people fewer times, or by fewer people many times. Therefore, embodiments of the present invention recognize the need for a system and method to selectively place one or more advertisements to maximize engagement by those who see or hear the message.

Embodiments of the present invention recognize that the key factors that limits engagement is uninteresting, irrelevant advertisements. Uninteresting, irrelevant advertisements result in the consumer immediately clicking the skip advertisement option, refreshing the page to avoid the advertisement, muting the volume, or tuning out the advertisement completely. Embodiments of the present invention recognize that there are several avenues to take to maximize engagement, including increasing advertisement viewership (or listenership) duration, increasing engagement with an advertisement (e.g., by clicking on the advertisement), and increasing viewer (or listener) count of the playback (i.e., the streamed playback).

Embodiments of the present invention provide a system and method to selectively place one or more advertisements in a playback to maximize user engagement. More specifically, embodiments of the present invention provide a system and method to selectively place one or more advertisements in a playback to maximize user engagement. More specifically, embodiments of the present invention analyze a playback selected by a user by performing a static scan as well as a dynamic scan. A playback may be, but is not limited to, a recording of audio and/or video. The static scan determines one or more places where an advertisement may be placed in the playback (i.e., advertisement insertion points).

Embodiments of the present invention divide the playback into two or more sections based on the position of the advertisement insertion points and associate a sound (or soundtrack) with each section. For an audio playback, the sound (or soundtrack) associated with the playback is embedded in the playback itself. For a video playback, embodiments of the present invention determine if there is a sound (or soundtrack) that can be aligned with the playback. Embodiments of the present invention divides an advertisement submitted by an advertisement sponsor into one or more categorical components. The advertisement submitted may have a plurality of categorical components. The plurality of categorical components may include, but are not limited to, an introduction, a problem statement, a product placement, a proposed solution, and a call to action. Embodiments of the present invention associate the sound (or soundtrack) of the playback with the advertisement and dynamically modify the advertisement depending on its categorical components to maximize user engagement. Lastly, embodiments of the present invention gather a set of data points on a set of parameters to further optimize the results to ensure the highest user engagement is achieved. The set of parameters may include, but are not limited to, determining which type of advertisement (i.e., a background advertisement or a foreground advertisement) is more effective; whether associating the advertisement with the playback sound yielded better results; and whether selecting the sound of the section as background music resulted in higher engagement than the sound from the highest peak.

Implementation of embodiments of the present invention may take a variety of forms, and exemplary implementation details are discussed subsequently with reference to the Figures.

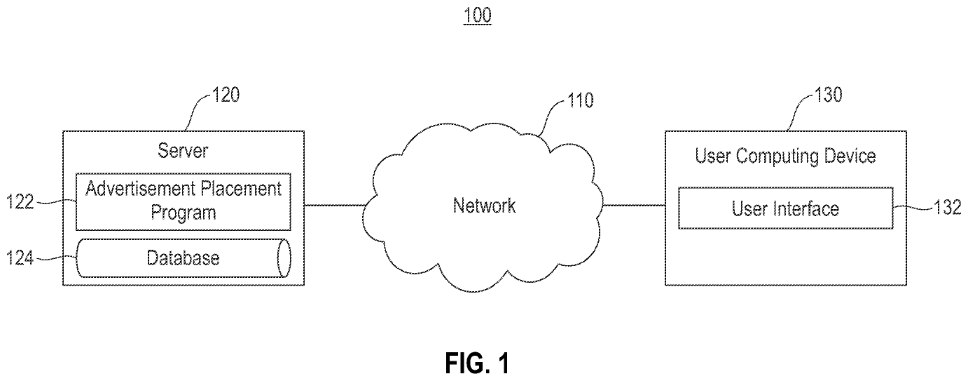

FIG. 1 is a block diagram illustrating a distributed data processing environment, generally designated 100, in accordance with an embodiment of the present invention. In the depicted embodiment, distributed data processing environment 100 includes server 120 and user computing device 130, interconnected over network 110. Distributed data processing environment 100 may include additional servers, computers, computing devices, IoT sensors, and other devices not shown. The term “distributed” as used herein describes a computer system that includes multiple, physically distinct devices that operate together as a single computer system. FIG. 1 provides only an illustration of one embodiment of the present invention and does not imply any limitations with regards to the environments in which different embodiments may be implemented. Many modifications to the depicted environment may be made by those skilled in the art without departing from the scope of the invention as recited by the claims.

Network 110 operates as a computing network that can be, for example, a telecommunications network, a local area network (LAN), a wide area network (WAN), such as the Internet, or a combination of the three, and can include wired, wireless, or fiber optic connections. Network 110 can include one or more wired and/or wireless networks capable of receiving and transmitting data, voice, and/or video signals, including multimedia signals that include data, voice, and video information. In general, network 110 can be any combination of connections and protocols that will support communications between server 120, user computing device 130, and other computing devices (not shown) within distributed data processing environment 100.

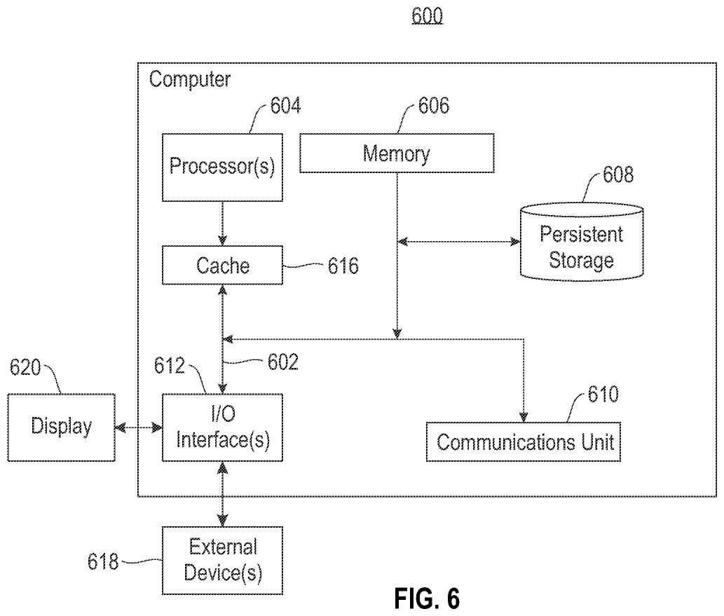

Server 120 operates to run advertisement placement program 122 and to send and/or store data in database 124. In an embodiment, server 120 can send data from database 124 to user computing device 130. In an embodiment, server 120 can receive data in database 124 from user computing device 130. In one or more embodiments, server 120 can be a standalone computing device, a management server, a web server, a mobile computing device, or any other electronic device or computing system capable of receiving, sending, and processing data and capable of communicating with user computing device 130 via network 110. In one or more embodiments, server 120 can be a computing system utilizing clustered computers and components (e.g., database server computers, application server computers, etc.) that act as a single pool of seamless resources when accessed within distributed data processing environment 100. In one or more embodiments, server 120 can be a laptop computer, a tablet computer, a netbook computer, a personal computer, a desktop computer, a personal digital assistant, a smart phone, or any programmable electronic device capable of communicating with user computing device 130 and other computing devices (not shown) within distributed data processing environment 100 via network 110. Server 120 may include internal and external hardware components, as depicted and described in further detail in FIG. 6.

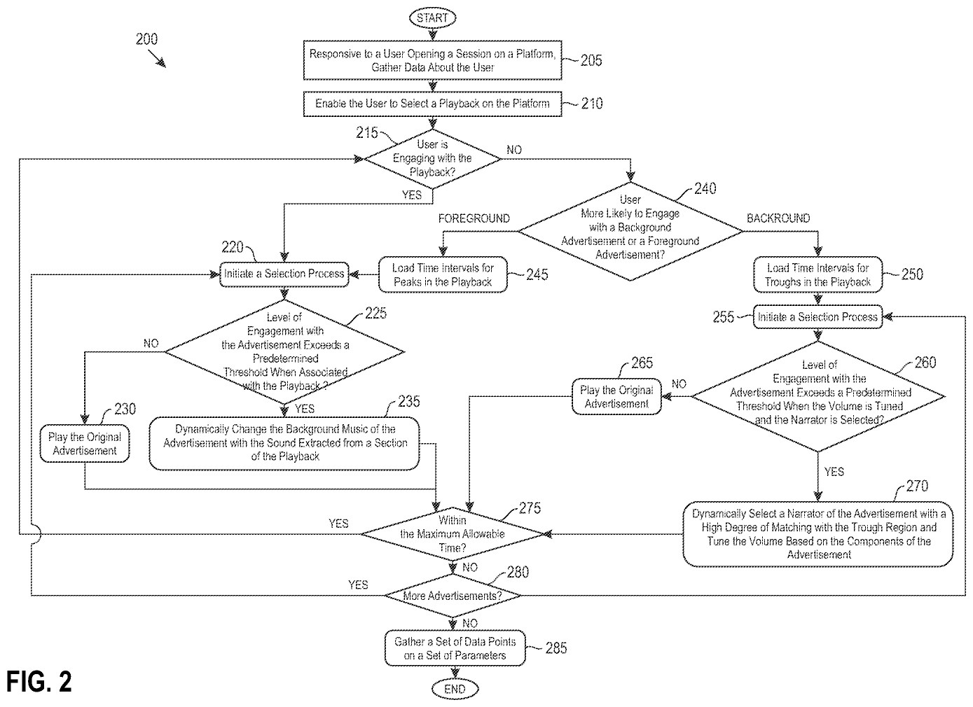

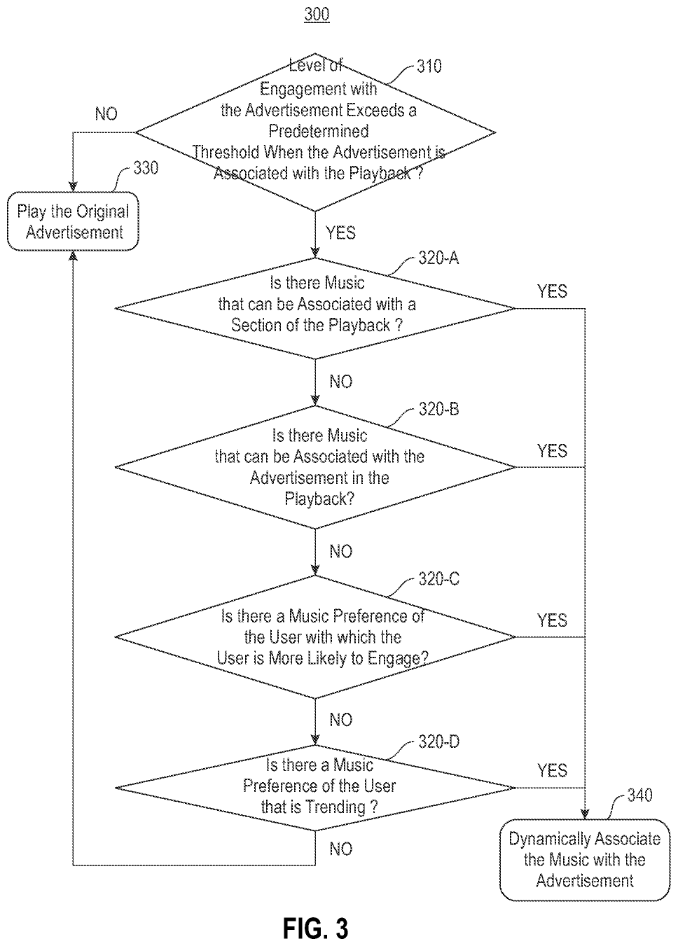

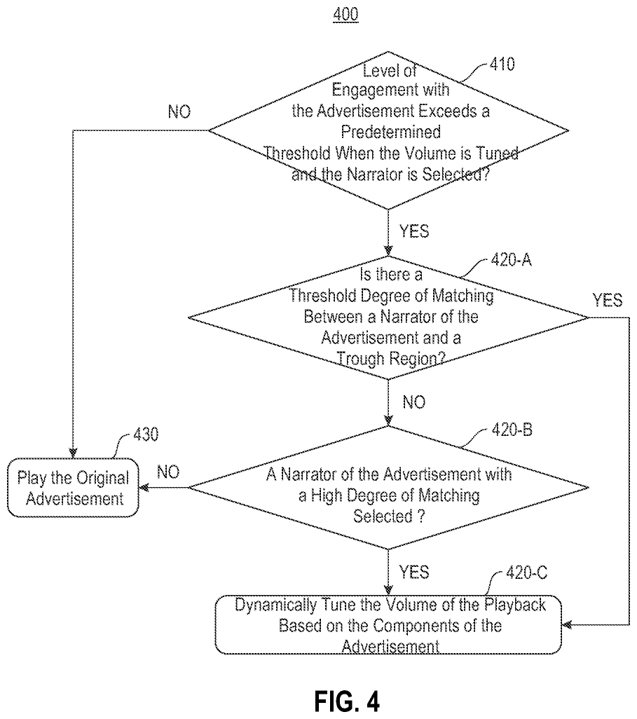

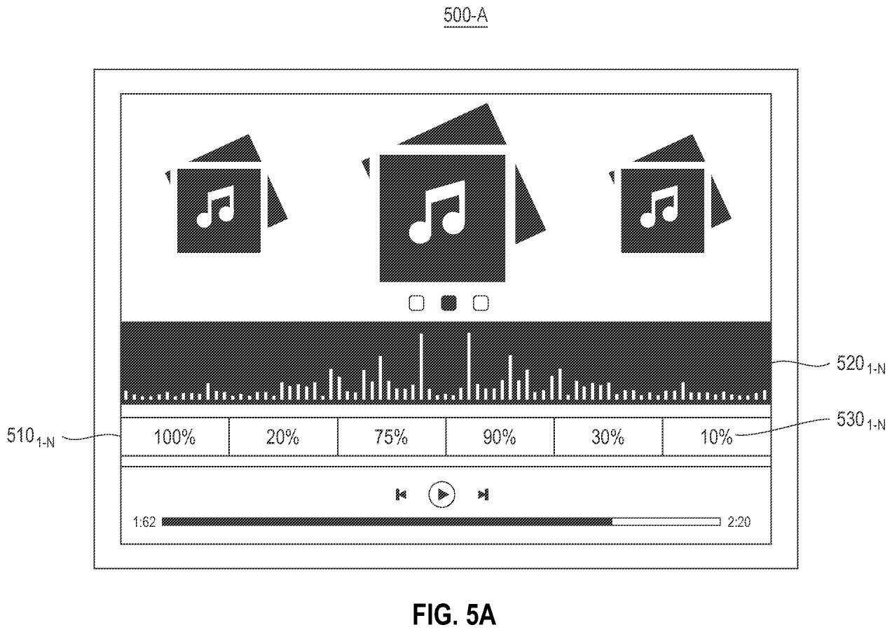

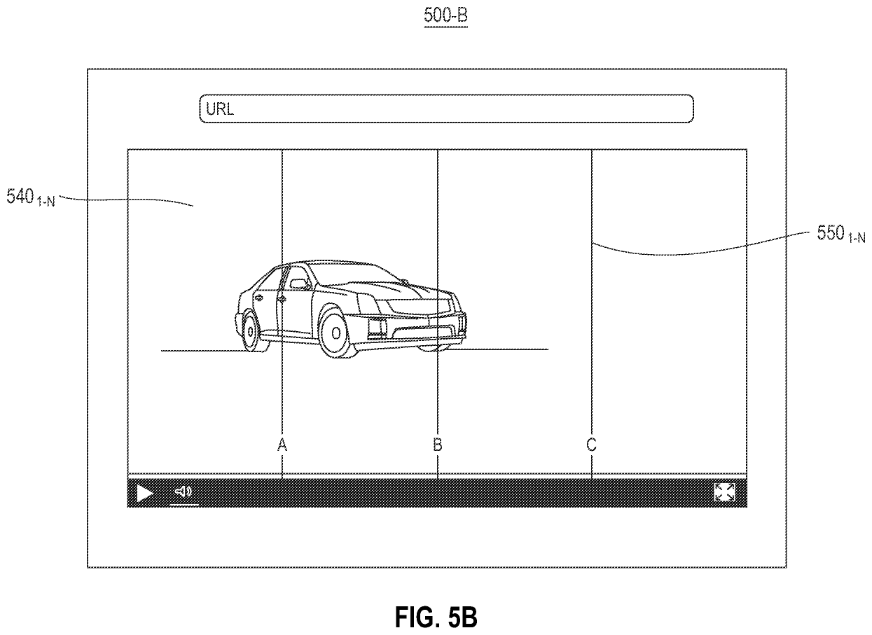

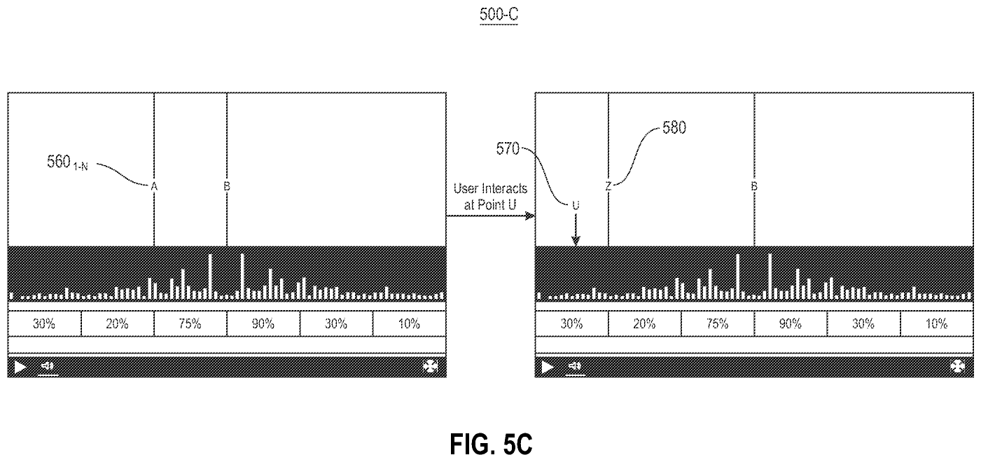

Advertisement placement program 122 operates to selectively place one or more advertisements in a playback to maximize user engagement. In the depicted embodiment, advertisement placement program 122 is a standalone program. In another embodiment, advertisement placement program 122 may be integrated into another software product, such as a marketing software, an audio streaming platform, a video streaming platform, a social media platform, and a gaming platform. In the depicted embodiment, advertisement placement program 122 resides on server 120. In another embodiment, advertisement placement program 122 may reside on user computing device 130 or on another computing device (not shown), provided that advertisement placement program 122 has access to network 110. The operational steps of advertisement placement program 122 are depicted and described in further detail with respect to FIG. 2. The operational steps of a change component of advertisement placement program 122 are depicted and described in further detail with respect to FIG. 3. The operational steps of a selection component of advertisement placement program 122 are depicted and described in further detail with respect to FIG. 4. An illustration of a platform where an audio playback is selected by a user to play is depicted and described in further detail with respect to FIG. 5A. An illustration of a platform where a video playback is selected by a user to play is depicted and described in further detail with respect to FIG. 5B. A representation of a static scan and a dynamic scan working in tandem is depicted and described in further detail with respect to FIG. 5C.

In an embodiment, the user of user computing device 130 registers with advertisement placement program 122 of server 120. For example, the user completes a registration process (e.g., user validation), provides information to create a user profile, and authorizes the collection, analysis, and distribution (i.e., opts-in) of relevant data on identified computing devices (e.g., on user computing device 130) by server 120 (e.g., via advertisement placement program 122). Relevant data includes, but is not limited to, personal information or data provided by the user or inadvertently provided by the user's device without the user's knowledge; tagged and/or recorded location information of the user (e.g., to infer context (i.e., time, place, and usage) of a location or existence); time stamped temporal information (e.g., to infer contextual reference points); and specifications pertaining to the software or hardware of the user's device. In an embodiment, the user opts-in or opts-out of certain categories of data collection. For example, the user can opt-in to provide all requested information, a subset of requested information, or no information. In one example scenario, the user opts-in to provide time-based information, but opts-out of providing location-based information (on all or a subset of computing devices associated with the user). In an embodiment, the user opts-in or opts-out of certain categories of data analysis. In an embodiment, the user opts-in or opts-out of certain categories of data distribution. Such preferences can be stored in database 124.

Database 124 operates as a repository for data received, used, and/or generated by advertisement placement program 122. A database is an organized collection of data. Data includes, but is not limited to, information about the user; information about user preferences (e.g., general user system settings such as alert notifications for user computing device 130); information about alert notification preferences; historical results of iterations of advertisement placement program 122; and any other data received, used, and/or generated by advertisement placement program 122.

Database 124 can be implemented with any type of device capable of storing data and configuration files that can be accessed and utilized by server 120, such as a hard disk drive, a database server, or a flash memory. In an embodiment, database 124 is accessed by advertisement placement program 122 to store and/or to access the data. In the depicted embodiment, database 124 resides on server 120. In another embodiment, database 124 may reside on another computing device, server, cloud server, or spread across multiple devices elsewhere (not shown) within distributed data processing environment 100, provided that advertisement placement program 122 has access to database 124.

The present invention may contain various accessible data sources, such as database 124, that may include personal and/or confidential company data, content, or information the user wishes not to be processed. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal and/or confidential company data. Advertisement placement program 122 enables the authorized and secure processing of personal data.

Advertisement placement program 122 provides informed consent, with notice of the collection of personal and/or confidential data, allowing the user to opt-in or opt-out of processing personal and/or confidential data. Consent can take several forms. Opt-in consent can impose on the user to take an affirmative action before personal and/or confidential data is processed. Alternatively, opt-out consent can impose on the user to take an affirmative action to prevent the processing of personal and/or confidential data before personal and/or confidential data is processed. Advertisement placement program 122 provides information regarding personal and/or confidential data and the nature (e.g., type, scope, purpose, duration, etc.) of the processing. Advertisement placement program 122 provides the user with copies of stored personal and/or confidential company data. Advertisement placement program 122 allows the correction or completion of incorrect or incomplete personal and/or confidential data. Advertisement placement program 122 allows for the immediate deletion of personal and/or confidential data.

User computing device 130 operates to run user interface 132 through which a user can interact with advertisement placement program 122 on server 120. In an embodiment, user computing device 130 is a device that performs programmable instructions. For example, user computing device 130 may be an electronic device, such as a laptop computer, a tablet computer, a netbook computer, a personal computer, a desktop computer, a smart phone, or any programmable electronic device capable of running user interface 132 and of communicating (i.e., sending and receiving data) with advertisement placement program 122 via network 110. In general, user computing device 130 represents any programmable electronic device or a combination of programmable electronic devices capable of executing machine readable program instructions and communicating with other computing devices (not shown) within distributed data processing environment 100 via network 110. In the depicted embodiment, user computing device 130 includes an instance of user interface 132.

User interface 132 operates as a local user interface between advertisement placement program 122 on server 120 and a user of user computing device 130. In some embodiments, user interface 132 is a graphical user interface (GUI), a web user interface (WUI), and/or a voice user interface (VUI) that can display (i.e., visually) or present (i.e., audibly) text, documents, web browser windows, user options, application interfaces, and instructions for operations sent from advertisement placement program 122 to a user via network 110. User interface 132 can also display or present alerts including information (such as graphics, text, and/or sound) sent from advertisement placement program 122 to a user via network 110. In an embodiment, user interface 132 is capable of sending and receiving data (i.e., to and from advertisement placement program 122 via network 110, respectively). Through user interface 132, a user can opt-in to advertisement placement program 122; create a user profile; set user preferences and alert notification preferences; input data about the user; open a session on a platform; select a playback on the platform; engage with the playback; play an original version of the advertisement; play a modified version of the advertisement; receive a request for feedback; and input feedback.

A user preference is a setting that can be customized for a particular user. A set of default user preferences are assigned to each user of advertisement placement program 122. A user preference editor can be used to update values to change the default user preferences. User preferences that can be customized include, but are not limited to, general user system settings; specific user profile settings; alert notification settings; machine-learned data collection/storage settings; a type of advertisement with which the user positively engages (i.e., a correct method of delivery, e.g., via an advertisement in the foreground or an advertisement in the background); a length of an advertisement (e.g., 15 seconds, 30 seconds, 45 seconds, and 1 minute); an audio playback with a musical component viewed and/or listened to most frequently (wherein the musical component can be extracted from the audio playback); a video playback with a musical component viewed and/or listened to most frequently (wherein the musical component can be extracted from the video playback); and a type of music listened to most frequently. Machine-learned data is a user's personalized corpus of data. Machine-learned data includes, but is not limited to, past results of iterations of advertisement placement program 122.

FIG. 2 is a flowchart, generally designated 200, illustrating the operational steps for advertisement placement program 122, on server 120 within distributed data processing environment 100 of FIG. 1, in accordance with an embodiment of the present invention. In an embodiment, advertisement placement program 122 operates to selectively place one or more advertisements in a playback to maximize user engagement. It should be appreciated that the process depicted in FIG. 2 illustrates one possible iteration of the process flow, which may be repeated each time a user opens a session on a platform.

In step 205, advertisement placement program 122 (hereinafter referred to as “program 122”) enables a user to open a session on a platform. In an embodiment, program 122 enables a user to open a session on a platform on a user computing device (e.g., user computing device 130) via a user interface (e.g., user interface 132). A user may be, but is not limited to, a person who uses a platform (e.g., to listen to musical song, audiobooks, lessons, and/or podcasts; to watch television shows and/or movies; to share content; and to game). A session is a period of time devoted to a particular activity (e.g., using the platform). A platform may include, but is not limited to, an audio streaming platform, a video streaming platform, a content crowdsourcing platform (i.e., a platform that collects content (e.g., videos, blog posts, reviews, and ratings) from a subset of users and shares the content with a wider user base on the platform), a data harvesting platform (i.e., a platform that offers a useful service to the user and generates data through usage of the platform), and a gaming platform.

In an embodiment, responsive to the user opening the session on the platform, program 122 gathers data about the user. In an embodiment, program 122 gathers data about the user from a user profile stored in a database (e.g., database 124). In another embodiment, program 122 gathers data about the user directly from the user through the user computing device (e.g., user computing device 130) via the user interface (e.g., user interface 132). Data about the user may include, but is not limited to, a preference(s) of the user. The preference(s) of the user are stored in the database (e.g., database 124). The preference(s) of the user are stored in the database (e.g., database 124) to reduce overhead in finding an advertisement for the user and yielding the best result. The preference(s) of the user may include, but are not limited to, a type of advertisement with which the user positively engages (i.e., a correct method of delivery, e.g., via an advertisement in the foreground or an advertisement in the background); a length of an advertisement (e.g., 15 seconds, 30 seconds, 45 seconds, and 1 minute); an audio playback with a musical component viewed and/or listened to most frequently (wherein the musical component can be extracted from the audio playback); a video playback with a musical component viewed and/or listened to most frequently (wherein the musical component can be extracted from the video playback); and a type of music listened to most frequently. The type of music listened to most frequently may be derived from a five-factor structure. The five-factor structure includes: 1) a type of music with a mellow factor defined by smooth and relaxing music; 2) a type of music with an urban factor defined by rhythmic and percussive music, such as is found in rap, funk, and acid jazz genres; 3) a type of music with a sophisticated factor, such as is found in classical operatic, world, and jazz genres; 4) a type of music with an intense factor defined by loud, forceful, and energetic music; and 5) a type of music with a campestral factor comprising a variety of different styles of direct and rootsy music, such as is found in country and singer-songwriter genres.

In step 210, program 122 enables the user to select a playback on the platform. In an embodiment, program 122 enables the user to select a playback on the platform on the user computing device (e.g., user computing device 130) via the user interface (e.g., user interface 132). In an embodiment, program 122 loads a set of configurations associated with the playback selected by the user. A playback may be, but is not limited to, a recording of audio and/or video. The content of a playback may be audio only (e.g., musical song, podcast, etc.) or audio and video (e.g., television show, movie, etc.). The content of a playback may be displayed in one of three states. The three states include not in focus, in focus without user interaction, or in focus with user interaction (e.g., a user clicks somewhere on a window or hovers over a window). A playback may also be referred to as a media item.

In an embodiment, responsive to the user selecting the playback on the platform, program 122 analyzes the playback. In an embodiment, program 122 performs a static scan of the playback. In an embodiment, program 122 performs a dynamic scan of the playback. A static scan operates to divide the playback into two or more sections and to determine a time interval of each section. A static scan also operates to determine the sound associated with each section. These data points (i.e., the time interval and the sound of each section) may be paired with the preferences of the user to determine whether it is more probable the user engages with a background advertisement or with a foreground advertisement and to determine where to insert advertisement insertion points. Program 122 reconciles the static scan with a dynamic scan to ensure that the maximum allowed time for an advertisement is not crossed (i.e., surpassed). A dynamic scan operates to determine where to insert advertisement insertion points in the foreground of the playback if the user is actively interacting with the playback. For example, a static scan advertisement insertion point following a dynamic scan advertisement insertion point may need to be adjusted to increase the intervals of time between advertisements (i.e., to minimize user frustration) and to remain within the maximum allowed time for an advertisement.

In an embodiment, program 122 identifies one or more events of the playback. In an embodiment, program 122 identifies a total length of time of each event of the one or more events identified (i.e., a time interval of each event). The one or more events identified may be one or more places where an advertisement may be placed (i.e., one or more advertisement insertion points). The one or more events identified may include one or more peaks and/or one or more troughs. The playback may consist entirely of peaks, entirely of troughs, or a mix of peaks and troughs. A peak is a section of the playback that is more probable for active viewing and/or active listening relative to the rest of the playback (i.e., highly viewed or viewed the most). A peak is also a section of the playback where the playback reaches a climax or a crescendo. A trough is a section of the playback that is less probable for active viewing and/or active listening relative to the rest of the playback (i.e., not highly viewed or viewed the least). A trough is also a section of the playback where the playback ascends or descends (i.e., to or from the climax or the crescendo). In another embodiment, program 122 identifies one or more events of the playback based on the preferences of the user (e.g., a type of advertisement with which the user positively engages (i.e., a correct method of delivery, e.g., via an advertisement in the foreground or an advertisement in the background)). In another embodiment, program 122 gathers external knowledge (i.e., for comparison to one or more alternative playbacks) via the library of the platform. The library contains all available playbacks on the platform.

In an embodiment, program 122 identifies the maximum allowed time for an advertisement. In an embodiment, program 122 identifies the maximum allowed time for an advertisement based on the one or more events identified (e.g., the advertisement may not exceed the total length of time of an event). In an embodiment, program 122 identifies the maximum allowed time for an advertisement based on the total length of time of the playback.

In an embodiment, program 122 divides the playback into two or more sections. In an embodiment, program 122 divides the playback into two or more sections based on the one or more events identified (e.g., into sections representing peaks and/or sections representing troughs). In an embodiment, program 122 divides the playback into two or more sections using a Fourier transform. In an embodiment, program 122 determines a length of time (i.e., a time interval) of each section. A section may also be referred to as a region. A section may represent a significant shift in scenes, volume, tempo, etc.

A Fourier transform (FT) is a mathematical function that decomposes a waveform, which is a function of time, into the individual frequencies that make it up. The result produced by the Fourier transform is a complex valued function of frequency. The absolute value of the Fourier transform represents the frequency value present in the original function and its complex argument represents the phase offset of the basic sinusoidal in that frequency. The Fourier transform is also called a generalization of the Fourier series. This term can be applied to both the frequency domain representation and the mathematical function used. The Fourier transform helps in extending the Fourier series to non-period functions, which allows viewing any functions as a sum of simple sinusoids. The Fourier transform of a function f(x) is defined as:

f(x)∫_{-∞}^{∞}F(k)e^{2πikx}dk

F(x)∫_{-∞}^{∞}f(k)e^{-2πikx}dx,

where F(k) can be obtained using inverse Fourier transform.

For example, for a fifteen-minute playback, the maximum allowed time for advertisements is 30 seconds. Program 122 determines that foregrounds advertisements yield higher engagement with a particular user based on the preferences of the user. The static scan traverses the playback, places advertisement insertion points at the 5:00 minute mark and the 11:00 minute mark. The placement of the advertisement insertion points was based on two peak regions identified in the playback. Each advertisement insertion point is marked to play a 15-second-long advertisement. The advertisement to be played at each advertisement insertion point is selected based on the popularity of the playback and the preferences of the advertisement sponsor and the user. If, while watching the playback, the user engages with the playback at the 8:00 minute mark, the dynamic scan may place an advertisement insertion point within the remaining allowed time (e.g., 15 seconds) of the section. If the advertisement to be played is only a 10-second-long advertisement, then, by the time the playback reaches the 11:00 minute mark, there is 5-seconds of advertisement time remaining. The dynamic scan may place a second advertisement insertion point at the 11:00 minute mark. The dynamic scan may place a 5-second-long advertisement at the second advertisement insertion point rather than the 15-second-long advertisement placed earlier by the static scan.

In decision step 215, program 122 determines whether the user is engaging with the playback. In an embodiment, program 122 determines whether the user is engaging with the playback through the user computing device (e.g., user computing device 130) via the user interface (e.g., user interface 132). If program 122 determines the user is engaging with the playback (decision step 215, YES branch), then program 122 proceeds to step 220, initiating a selection process of an advertisement. If program 122 determines the user is not engaging with the playback (decision step 215, NO branch), then program 122 proceeds to step 240, determining which type of advertisement is preferred by the user.

In step 220, program 122 initiates a selection process of an advertisement. The selection process may include selecting an advertisement based on one or more factors. The one or more factors may include, but are not limited to, a maximum time allowed for an advertisement and a popularity of a playback. An advertisement is a paid notice or announcement promoting a product, a service, or an event in a public medium, such as in a newspaper or a magazine, on a radio or a television, or on the internet. An advertisement, in the present invention, may have text only (i.e., a banner), audio only, or text and audio. An advertisement may appear in the background (hereinafter referred to as a “background advertisement”) or in the foreground (hereinafter referred to as a “foreground advertisement”). A background advertisement is an advertisement that can be placed in a trough with minimal user engagement or no user engagement. A foreground advertisement is an advertisement that can be placed prior to a peak to incentivize the user to engage with the advertisement. A background advertisement is an advertisement that is quieter, easier to ignore, more continuous, less variable, and broader in spectrum, whereas a foreground advertisement is an advertisement that is louder, more intrusive, composed of recognizable events, changeable, and repeated in particular frequencies. Each advertisement can be provided to the user for a maximum amount of time (i.e., an overall amount of time).

In an embodiment, program 122 selects a potential advertisement. In an embodiment, program 122 divides the potential advertisement into one or more categorical components. The potential advertisement submitted by an advertisement sponsor may have a plurality of categorical components. The plurality of categorical components may include, but are not limited to, an introduction, a problem statement, a product placement, a proposed solution, and a call to action. In an embodiment, program 122 divides the potential advertisement into one or more categorical components manually (i.e., by marking the one or more sections of the potential advertisement). In another embodiment, program 122 divides the potential advertisement into one or more categorical components using a trained algorithm.

In another embodiment, when an advertisement sponsor wants tighter control over which advertisement is played during a playback and/or at which point the advertisement is played during a playback, program 122 enables the advertisement sponsor to configure the playback with one or more specific advertisements at one or more specific advertisement insertion points. However, program 122 may provide the user with both configurations—the advertisement sponsor configuration and the algorithm designed configuration. Program 122 may then provide the advertisement sponsor with metrics showing which configuration yielded better results. The advertisement sponsor configuration option may be achieved similar to how the static scan marks the advertisement insertion points. The advertisement sponsor may select two or more sections of the playback, and mark the two or more sections as advertisement insertion points. The advertisement sponsor may then select which advertisement needs to be inserted at each advertisement insertion point. Moreover, the advertisement sponsor configuration option should be made extrapolatable such that the same configuration for the video playback can be applied to a series of matching video playbacks selected by the advertisement sponsor. This can be done by scanning where the advertisement sponsor has previously added advertisement insertion points (e.g., in certain peaks and troughs). In cases where it is unclear, the advertisement sponsor can resolve the issue manually.

In decision step 225, program 122 determines whether a level of engagement by the user with the potential advertisement (i.e., through audio) exceeds a predetermined threshold when the potential advertisement is associated with the playback. If program 122 determines the level of engagement by the user with the potential advertisement does not exceed the predetermined threshold when the potential advertisement is associated with the playback (decision step 255, NO branch), then program 122 proceeds to step 230, playing an original version of the advertisement. If program 122 determines the level of engagement by the user with the potential advertisement exceeds the predetermined threshold when the potential advertisement is associated with the playback (decision step 225, YES branch), then program 122 proceeds to step 235, dynamically changing the background music of the advertisement with sound extracted from the respective section of the playback.

In step 230, program 122 plays an original version of the advertisement. In an embodiment, program 122 plays an original version of the advertisement on the user computing device (e.g., user computing device 130) via the user interface (e.g., user interface 132). In an embodiment, program 122 proceeds to step 275 to execute the time process.

In step 235, for an audio playback and/or a video playback, program 122 associates a sound (or soundtrack) with each section of the playback. In an embodiment, program 122 associates a sound (or soundtrack) with each section of the playback manually by marking points of association between the sound (or soundtrack) and each section of the playback. In another embodiment, program 122 associates a sound (or soundtrack) with each section of the playback using an algorithm. The algorithm searches the library of the platform for content matching each section of the playback. In an embodiment, program 122 ensures the sound (or soundtrack) can be used as a background advertisement seamlessly if the advertisement is inserted at a specific point in the playback.

In an embodiment, for an audio playback (e.g., a musical song), the sound (or soundtrack) associated with each section of the audio playback is embedded in the audio playback. However, if there is an instrumental version of the audio playback, then the audio playback is synced with the sound (or soundtrack). Depending on the user, an instrumental sound of a preferred playback may result in higher engagement than the actual playback.

In an embodiment, for a video playback (e.g., a movie scene), program 122 determines if there is a sound (or soundtrack) associated that can be aligned with the video playback (e.g., a movie preview with a soundtrack associated with all of the background scenes). If the video playback does not have a sound (or soundtrack) associated, then program 122 scans the preferences of the user and leverages the preferences of the user.

In another embodiment, for a video game playback, program 122 associates a characteristic of a sound (or soundtrack) of a game (e.g., a video game) with the advertisement. In an embodiment, program 122 extracts the sound (or soundtrack) from the game. In another embodiment, program 122 obtains a sample of the sound (or soundtrack) from the game and places the sample as the background music for a foreground advertisement. In another embodiment, program 122 embeds a background advertisement if the user is not actively engaging with the platform at a given time.

In an embodiment, program 122 dynamically changes the background music of the advertisement with sound extracted from a respective section of the playback. Step 235, specifically how the background music of the advertisement is dynamically changed, is described in further detail with respect to flowchart 300 in FIG. 3.

In an embodiment, program 122 presents the updated advertisement in the playback to the user. In an embodiment, program 122 presents the updated advertisement in the playback to the user through the user computing device (e.g., user computing device 130) via the user interface (e.g., user interface 132).

In decision step 240, program 122 determines which type of advertisement is preferred by the user (i.e., a background advertisement or a foreground advertisement). In other words, program 122 determines whether it is more likely the user will engage with a probable advertisement placed in a foreground section of the playback or a background section of the playback. In an embodiment, program 122 determines whether it is more likely the user will engage with a probable advertisement placed in a foreground section of the playback or a background section of the playback based on one or more metrics gathered about the user (e.g., the data gathered about the user in step 205).

If it is more likely the user will engage with a probable advertisement placed in a foreground section of the playback prior to a peak region, then program 122 uses that method to serve the advertisement to the user (i.e., the foreground pathway, i.e., step 245). If it is more likely the user will engage with a probable advertisement placed in a trough region, then program 122 (i.e., through the static scan) uses the trough region as an advertisement insertion point. If it is more likely the user will engage with the playback at a trough region that was marked as an advertisement insertion point for a probable background advertisement, then the dynamic scan may remove the probable background advertisement from the trough region and place a probable foreground advertisement in that region or in the region immediately following the trough region.

In an embodiment, program 122 selects either a background advertisement or a foreground advertisement to provide to the user if there is no historical data on the user stored in the database (e.g., database 124). In an embodiment, program 122 stores the results of this iteration of program 122 in the database (e.g., database 124) to be used during future iterations of program 122.

If program 122 determines it is more likely the user will engage with a probable advertisement placed in a foreground section of the playback (decision step 240, FOREGROUND ADVERTISEMENT branch), then program 122 proceeds to step 245, loading a set of time intervals associated with the peak regions of the playback. In step 245, program 122 loads a set of time intervals associated with the peak regions of the playback. When the set of time intervals associated with the peak regions of the playback are fully loaded, then program 122 returns to step 220, initiating the selection process of the advertisement.

If program 122 determines it is more likely the user will engage with a probable advertisement placed in a background section of the playback (decision step 240, BACKGROUND ADVERTISEMENT branch), then program 122 proceeds to step 250, loading a set of interval times associated with the trough regions of the playback. In step 250, program 122 loads a set of time intervals associated with the trough regions of the playback. When the set of time intervals associated with the trough regions of the playback are fully loaded, then program 122 proceeds to step 255, initiating a selection process of the advertisement.

In step 255, program 122 initiates a selection process of the advertisement. The selection process may include selecting an advertisement based on one or more factors. The one or more factors may include, but are not limited to, a maximum time allowed for an advertisement and a popularity of a playback.

In an embodiment, program 122 selects a potential advertisement. In an embodiment, program 122 divides the potential advertisement into one or more categorical components. The potential advertisement submitted by an advertisement sponsor may have a plurality of categorical components. The plurality of categorical components may include, but are not limited to, an introduction, a problem statement, a product placement, a proposed solution, and a call to action. In an embodiment, program 122 divides the potential advertisement into one or more categorical components manually (i.e., by marking the one or more sections of the potential advertisement). In another embodiment, program 122 divides the potential advertisement into one or more categorical components using a trained algorithm.

In decision step 260, program 122 determines whether the level of engagement by the user with the potential advertisement exceeds a predetermined threshold when a volume of the potential advertisement is tuned and a narrator of the potential advertisement is selected. If program 122 determines the level of engagement does not exceed the predetermined threshold (decision step 260, NO branch), then program 122 proceeds to step 265, playing an original version of the advertisement. In step 265, program 122 plays an original version of the advertisement. In an embodiment, program 122 plays an original version of the advertisement on the user computing device (e.g., user computing device 130) via the user interface (e.g., user interface 132). In an embodiment, program 122 proceeds to step 275 to execute the time process.

If program 122 determines the level of engagement exceeds the predetermined threshold (decision step 260, YES branch), then program 122 proceeds to step 270, dynamically selecting a narrator of the advertisement (i.e., a version of the advertisement) with a degree of matching with a trough region. In step 270, program 122 selects a narrator of the advertisement (i.e., a version of the advertisement) with a degree of matching with a trough region based on one or more components of the advertisement. In an embodiment, program 122 dynamically tunes the volume of the advertisement based on one or more components of the advertisement. In an embodiment, program 122 proceeds to step 275 to execute the time process. Step 270, specifically how the narrator of the advertisement is selected, is described in further detail with respect to flowchart 400 in FIG. 4.

In an embodiment, program 122 presents the updated advertisement in the playback to the user. In an embodiment, program 122 presents the updated advertisement in the playback to the user through the user computing device (e.g., user computing device 130) via the user interface (e.g., user interface 132).

In decision step 275, program 122 determines whether the advertisement is within a maximum allowable time. The advertisement is within the maximum allowable time if the length of the advertisement is equivalent to the maximum allowable time. The advertisement is not within the maximum allowable time if the length of the advertisement is less than the maximum allowable time. If program 122 determines the advertisement is within the maximum allowable time (decision step 275, YES branch), then program 122 returns to decision step 215, determining whether the user is engaging with the playback. If program 122 determines the advertisement is not within the maximum allowable time (decision step 275, NO branch), then program 122 proceeds to decision step 280, determining whether there are one or more advertisements available.

In decision step 280, program 122 periodically checks for one or more advertisements. In an embodiment, program 122 determines whether there are one or more advertisements available. If program 122 determines there are one or more advertisements available (decision step 280, YES branch), then program 122 returns to the selection process (i.e., steps 220 and 255). If program 122 determines there are no other advertisements available (decision step 280, NO branch), then program 122 continues to periodically check for one or more advertisements and proceeds to step 285, gathering a set of data points on a set of parameters.

In step 285, program 122 gathers a set of data points on a set of parameters. In an embodiment, program 122 gathers a set of data points on a set of parameters to further optimize the results to ensure the highest user engagement is achieved. In an embodiment, program 122 gathers a set of data points on a set of parameters to optimize a future updated advertisement. The set of parameters are actively modified to better serve the user. Each parameter may be recorded and compared against a control, as well as each other to optimize the results. The set of parameters may include, but are not limited to, determining which type of advertisement (i.e., a background advertisement or a foreground advertisement) is more effective; whether associating the advertisement with the playback sound yielded better results; and whether selecting the sound of the section as background music resulted in higher engagement than the sound from the highest peak.

It is necessary to determine whether associating the advertisement with the playback sound yielded better results. For foreground advertisements, this is based on user engagement recorded when the advertisement is dynamically modified with the sound as opposed to playing the advertisement without any modification. The configuration that yields the better engagement (as well as better engagement with the playback) should be provided to the user in a greater degree. For background advertisements, ensuring that this does not cost viewership (or listenership) is crucial. If the background advertisement results in positive engagement, then the background advertisement should be provided to the user in a greater degree.

It is necessary to determine whether selecting the sound of the section as background music resulted in higher engagement than the sound from the highest peak. This is necessary to ensure that program 122 is associating the best sound from the playback with the advertisement. The sound near the advertisement insertion point may be a peak, but not something specific to the user. In which case, it is better to associate the sound from the highest peak with the advertisement. Using data points to compare which configuration yields the better engagement will result in the user being provided a configuration with a higher chance of engagement.

The playback is monitored to measure user engagement via one or more factors. The one or more factors may include, but are not limited to, viewership (or listenership) duration of the advertisement (e.g., user A watched the first 5 seconds of the advertisement and then pressed the skip option); engagement with the advertisement (e.g., user B clicked on the advertisement playing in the foreground or user C paused the advertisement during the background advertisement and refreshed the page); and viewership (or listenership) count for the playback (i.e., a number of users who watched the playback after the insertion of the advertisements, e.g., the impact of an advertisement associated with a soundtrack from a user-preferred playback versus the impact of an original advertisement submitted by the advertisement sponsor).

FIG. 3 is a flowchart, generally designated 300, illustrating, in greater detail, the operational steps of a change component (e.g., step 235) of advertisement placement program 122, on server 120 within distributed data processing environment 100 of FIG. 1, in accordance with an embodiment of the present invention. In an embodiment, advertisement placement program 122 operates to dynamically change the background music of the advertisement with sound extracted from a respective section of the playback. It should be appreciated that the process depicted in FIG. 3 illustrates one possible iteration of the process flow, which may be repeated each time the background music of the advertisement is dynamically changed.

In decision step 310, program 122 determines whether a level of engagement by the user with the potential advertisement (i.e., through audio) exceeds a predetermined threshold when the potential advertisement is associated with the playback. If program 122 determines the level of engagement by the user with the potential advertisement does not exceed the predetermined threshold when the potential advertisement is associated with the playback (decision step 310, NO branch), then program 122 proceeds to step 330, playing an original version of the advertisement. If program 122 determines the level of engagement by the user with the potential advertisement exceeds the predetermined threshold when the potential advertisement is associated with the playback (decision step 310, YES branch), then program 122 proceeds to step 320-A, determining whether there is music that can be associated with a section of the playback.

In step 330, program 122 plays an original version of the advertisement. In an embodiment, program 122 plays an original version of the advertisement on the user computing device (e.g., user computing device 130) via the user interface (e.g., user interface 132). In an embodiment, responsive to playing the original version of the advertisement, program 122 returns to execute the time process (step 275 of FIG. 2).

In decision step 320-A, program 122 determines whether there is music that can be associated with a section of the playback. If program 122 determines there is music that can be associated with a section of the playback (decision step 320-A, YES branch), then program 122 proceeds to step 340, dynamically associating the music with the advertisement. If program 122 determines there is no music that can be associated with a section of the playback (decision step 320-A, NO branch), then program 122 proceeds to decision step 320-B, determining whether there is music that can be associated with the advertisement in the playback.

In decision step 320-B, program 122 determines whether there is music that can be associated with the advertisement in the playback. If program 122 determines there is music that can be associated with the advertisement in the playback (decision step 320-B, YES branch), then program 122 proceeds to step 340, dynamically associating the music with the advertisement. If program 122 determines there is no music that can be associated with the advertisement in the playback (decision step 320-B, NO branch), then program 122 proceeds to decision step 320-C, determining whether there is a music preference of the user with which the user is more likely to engage.

In decision step 320-C, program 122 determines whether there is a music preference of the user with which the user is more likely to engage. If program 122 determines there is a music preference of the user with which the user is more likely to engage (decision step 320-C, YES branch), then program 122 proceeds to step 340, dynamically associating the music with the advertisement. If program 122 determines there is no music preference of the user with which the user is more likely to engage (decision step 320-C, NO branch), then program 122 proceeds to decision step 320-D, determining whether there is a music preference of the user that is trending.

In decision step 320-D, program 122 determines whether there is a music preference of the user that is trending. If program 122 determines there is music preference of the user that is trending (decision step 320-D, YES branch), then program 122 proceeds to step 340, dynamically associating the music with the advertisement. If program 122 determines there is no music preference of the user that is trending (decision step 320-D, NO branch), then program 122 returns to step 330, playing the original version of the advertisement.

In step 340, program 122 dynamically associates the music with the advertisement.

FIG. 4 is a flowchart, generally designated 400, illustrating, in greater detail, the operational steps of a selection component (e.g., step 270) of advertisement placement program 122, on server 120 within distributed data processing environment 100 of FIG. 1, in accordance with an embodiment of the present invention. In an embodiment, advertisement placement program 122 operates to select a narrator of the advertisement (i.e., a version of the advertisement) with a degree of matching with a trough region based on one or more components of the advertisement. The advertisement may be layered on top of the trough region. When the advertisement is layered on top of the trough region, two parameters may be modified. The two parameters include tuning the volume of the playback and selecting a narrator (i.e., a foreground voice) of the advertisement based on one or more components of the advertisement. It should be appreciated that the process depicted in FIG. 4 illustrates one possible iteration of the process flow, which may be repeated each time a version of the advertisement is selected by advertisement placement program 122.

In decision step 410, program 122 determines whether the level of engagement by the user with the potential advertisement exceeds a predetermined threshold when a volume of the potential advertisement is tuned and a narrator of the potential advertisement is selected. If program 122 determines the level of engagement does not exceed the predetermined threshold (decision step 410, NO branch), then program 122 proceeds to step 430, playing an original version of the advertisement. In step 430, program 122 plays an original version of the advertisement. In an embodiment, program 122 plays an original version of the advertisement on the user computing device (e.g., user computing device 130) via the user interface (e.g., user interface 132). In an embodiment, program 122 returns to execute the time process (step 275 of FIG. 2).

If program 122 determines the level of engagement exceeds the predetermined threshold (decision step 410, YES branch), then program 122 proceeds to decision step 420-A, determining whether there is a threshold degree of matching between a first version of the narrator of the advertisement and a first trough region of the one or more trough regions of the playback.

In decision step 420-A, program 122 determines whether there is a threshold degree of matching between a first version of the narrator of the advertisement and a first trough region of the one or more trough regions of the playback. In an embodiment, program 122 assigns a degree of matching between each version of the narrator of the advertisement and each trough region of the one or more trough regions of the media item. If the degree of matching is low, playing the advertisement during the playback will result in negative engagement.

If program 122 determines there is a threshold degree of matching between the first version of the narrator of the advertisement and the first trough region of the one or more trough regions of the playback (decision step 420-A, YES branch), then program 122 proceeds to step 420-C, dynamically tuning the volume of the playback based on the components of the advertisement. If program 122 determines there is not a threshold degree of matching between the first version of the narrator of the advertisement and the first trough region of the one or more trough regions of the playback (decision step 420-A, NO branch), then program 122 proceeds to decision step 420-B, filtering out the versions of the narrator of the advertisement that do not exceed the threshold degree of matching.

In decision step 420-B, program 122 filters out the version of the narrator of the advertisement that do not exceed the threshold degree of matching.

In an embodiment, program 122 filters through the available versions of the narrator of the advertisement. The available versions of the narrator of the advertisement include the one or more versions of the narrator of the advertisement submitted by the advertisement sponsor. In an embodiment, program 122 selects a version of the narrator (i.e., foreground voice) of the advertisement. In an embodiment, program 122 selects a version of the narrator (i.e., foreground voice) of the advertisement based on a degree of matching (i.e., between the advertisement and the playback). In an embodiment, program 122 selects a version of the narrator (i.e., foreground voice) of the advertisement with the highest degree of matching (i.e., to the advertisement insertion points of the playback). In an embodiment, program 122 selects a version of the narrator (i.e., foreground voice) of the advertisement using Fast Fourier transform of the audio regions and the advertisement that does a comparison and storing match.

It is imperative to select a version of the narrator (i.e., foreground voice) of the advertisement with the highest degree of matching (i.e., between the version of the narrator and the advertisement insertion point of the playback). The high degree of matching will allow for a smooth transition, rather than shocking the user with a sudden tonal shift. It is critical for program 122 to ensure a smooth layering of the advertisement into the audio playback. If the layering is too jarring, the user will engage negatively with the playback. For example, placing a loud, over-the-top enunciating voice over a region of soft, mellow soundtrack cannot be allowed to happen because it may cause the user to pause the audio playback, refresh the page, etc.

In an embodiment, program 122 determines whether a version of the narrator of the advertisement with the highest degree of matching has been selected. If program 122 determines a version of the narrator of the advertisement with the highest degree of matching has been selected (decision step 420-B, YES branch), then program 122 proceeds to step 420-C, dynamically tuning the volume of the playback based on the components of the advertisement. If program 122 determines a version of the narrator of the advertisement with the highest degree of matching has not been selected (decision step 420-B, NO branch), then program 122 proceeds to step 430, playing an original version of the advertisement.

In step 420-C, program 122 dynamically tunes the volume of the playback based on the components of the advertisement. In an embodiment, program 122 dynamically tunes the volume of the playback for maximum engagement. There are two routes that can be taken. The first route involves using a constant volume throughout the advertisement. The second route involves varying the volume of the advertisement based on the content of the advertisement. To engage the user more, program 122 may gradually increase the volume of the advertisement until the climax in order to build tension and then gradually decrease the volume following the climax.

For example, for a background advertisement, where the user is not interacting with the playback and the playback is currently in a trough region, program 122 layers the advertisement to play with the playback. Depending on the user's history, program 122 may tune the advertisement so that the volume changes in accordance with the components of the advertisement. This means program 122 tunes the advertisement dynamically so that the audio reaches a maximum volume level at the climax and then diminishes following the climax.

FIG. 5A is an exemplary diagram, generally designated 500-A, illustrating a platform where an audio playback is selected by a user to play, on server 120 within distributed data processing environment 100 of FIG. 1, in accordance with an embodiment of the present invention. Program 122 divides the audio playback selected into six sections (e.g., 510_{1-N}). Each of the six sections last an equal duration of time. The six sections contain a mix of peaks and troughs (e.g., 520_{1-N}). The peaks are represented by the taller bars and the troughs are represented by the lower bars. Additionally, the percentages (e.g., 530_{1-N}) below the bars represent the number of users who have listened to a particular region.

FIG. 5B is an exemplary diagram, generally designated 500-B, illustrating a platform where a video playback is selected by a user to play, on server 120 within distributed data processing environment 100 of FIG. 1, in accordance with an embodiment of the present invention. Program 122 divides the video playback selected into four sections (e.g., 540_{1-N}). Program 122 scans the video playback selected and associates a soundtrack with each section of the one or more sections of the playback. The lines (e.g., 550_{1-N}) dividing the video represent a change in soundtracks. Therefore, there would be four soundtracks, each associated with a separate section. Soundtrack W is associated with the period of time from the start of the playback to A; soundtrack X is associated with the period of time from A to B; soundtrack Y is associated with the period of time from B to C; and soundtrack Z is associated with the period of time from C to the end of the playback.

FIG. 5C is an exemplary diagram, generally designated 500-C, illustrating a static scan and a dynamic scan working in tandem, on server 120 within distributed data processing environment 100 of FIG. 1, in accordance with an embodiment of the present invention. The image on the left indicates points marked by the static scan as advertisement insertion points, A and B (e.g., 560_{1-N}). Advertisement placement program 122, however, notices user interaction in a trough region (e.g., 570), so the dynamic scan adds an insertion point (e.g., 580), and works with the static scan to remove advertisement insertion point A to avoid cluttering in a small-time window.

FIG. 6 is a block diagram illustrating the components of computing device 600, suitable for server 120 running advertisement placement program 122 within distributed data processing environment 100 of FIG. 1, in accordance with an embodiment of the present invention. It should be appreciated that FIG. 6 provides only an illustration of one implementation and does not imply any limitations with regard to the environments in which different embodiments can be implemented. Many modifications to the depicted environment can be made.

As depicted, computing device 600 includes communications fabric 602, processor(s) 604, memory 606, persistent storage 608, communications unit 610, input/output (I/O) interface(s) 612, and cache 616. Communications fabric 602 provides communications between memory 606, cache 616, persistent storage 608, input/output (I/O) interface(s) 612, and communications unit 610. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses or a cross switch.

Memory 606 and persistent storage 608 are computer readable storage media. In this embodiment, memory 606 includes random access memory (RAM). In general, memory 606 can include any suitable volatile or non-volatile computer readable storage media. Cache 616 is a fast memory that enhances the performance of computer processor(s) 604 by holding recently accessed data, and data near accessed data, from memory 606.

Program instructions and data (e.g., software and data) used to practice embodiments of the present invention may be stored in persistent storage 608 and in memory 606 for execution by one or more of the respective processor(s) 604 via cache 616. In an embodiment, persistent storage 608 includes a magnetic hard disk drive. Alternatively, or in addition to a magnetic hard disk drive, persistent storage 608 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer readable storage medium that is also part of persistent storage 608. Software and data can be stored in persistent storage 608 for access and/or execution by one or more of the respective processor(s) 604 via cache 616. With respect to user computing device 130, software and data includes user interface 132. With respect to server 120, software and data includes advertisement placement program 122.

Communications unit 610, in these examples, provides for communications with other data processing systems or devices. In these examples, communications unit 610 includes one or more network interface cards. Communications unit 610 may provide communications through the use of either or both physical and wireless communications links. Program instructions and data (e.g., software and data) used to practice embodiments of the present invention may be downloaded to persistent storage 608 through communications unit 610.

I/O interface(s) 612 allows for input and output of data with other devices that may be connected to each computer system. For example, I/O interface(s) 612 may provide a connection to external device(s) 618, such as a keyboard, a keypad, a touch screen, and/or some other suitable input device. External device(s) 618 can also include portable computer readable storage media, such as, for example, thumb drives, portable optical or magnetic disks, and memory cards. Program instructions and data (e.g., software and data) used to practice embodiments of the present invention can be stored on such portable computer readable storage media and can be loaded onto persistent storage 608 via I/O interface(s) 612. I/O interface(s) 612 also connect to display 620.

Display 620 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

While particular embodiments of the present invention have been shown and described here, it will be understood to those skilled in the art that, based upon the teachings herein, changes and modifications may be made without departing from the embodiments and its broader aspects. Therefore, the appended claims are to encompass within their scope all such changes and modifications as are within the true spirit and scope of the embodiments.

Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understand, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to embodiments containing only one such element, even when the same claim includes the introductory phrases “at least one” or “one or more” and indefinite articles such as “a” or “an”, the same holds true for the use in the claims of definite articles.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart illustrations and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart illustrations and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart illustrations and/or block diagram block or blocks.

The flowchart illustrations and block diagrams in the Figures illustrate the architecture, functionality, and operation of possible implementations of systems, methods, and computer program products according to various embodiments of the present invention. In this regard, each block in the flowchart illustrations or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each flowchart illustration and/or block of the block diagrams, and combinations of flowchart illustration and/or blocks in the block diagrams, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
determining, by one or more processors, whether a user is engaging with a media item on a platform by measuring one or more user engagement factors;
responsive to determining the user is not engaging with the media item, analyzing, by the one or more processors, the media item to identify an event, wherein the event is a place where a potential advertisement may be inserted in the media item to maximize user engagement, wherein the event includes at least one of a peak region and a trough region, and wherein the peak region is an area with maximum user engagement and is referred to as a foreground section of the media item and the trough region is an area with minimal user engagement and is referred to as a background section of the media item;
gathering, by the one or more processors, one or more metrics about the user to determine whether it is more likely the user will engage with the potential advertisement if the potential advertisement is placed in the foreground section of the media item or the background section of the media item;
responsive to determining it is more likely the user will engage with the potential advertisement if the potential advertisement is placed in the foreground section of the media item, loading, by the one or more processors, a set of time intervals associated with the peak region of the media item;
selecting, by the one or more processors, an advertisement to be placed in the media item;
associating, by the one or more processors, the advertisement with the media item;
dynamically changing, by the one or more processors, a background music of the advertisement based on the event of the media item to produce an updated advertisement; and
presenting, by the one or more processors, the updated advertisement in the media item to the user.

2. The computer-implemented method of claim 1, wherein analyzing the media item to identify an event further comprises:
identifying, by the one or more processors, whether there are any peak regions in the media item; and
identifying, by the one or more processors, whether there are any trough regions in the media item.

3. The computer-implemented method of claim 2, further comprising:
subsequent to identifying whether there are the any trough regions in the media item, dividing, by the one or more processors, the media item into two or more sections based on the any peak regions identified and the any trough regions identified using a Fourier transform;
determining, by the one or more processors, a time interval of each section of the two or more sections; and
associating, by the one or more processors, a sound with each section of the two or more sections.

4. The computer-implemented method of claim 1, wherein the advertisement is selected
based on one or more factors, wherein the one or more factors includes a maximum amount of time allowed for the advertisement and a popularity of the media item.

5. (canceled)

6. The computer-implemented method of claim 1, wherein dynamically changing the background music of the advertisement based on the event of the media item to produce the updated advertisement further comprises:
determining, by the one or more processors, whether there is music that can be associated with a first section of the two or more sections of the media item;
responsive to determining there is no music that can be associated with the first section of the two or more sections of the media item, determining, by the one or more processors, whether there is music that can be associated with the advertisement in the media item;
responsive to determining there is no music that can be associated with the advertisement in the media item, determining, by the one or more processors, if there is a first music preference of the user with which the user is more likely to engage;
responsive to determining there is no first music preference of the user with which the user is more likely to engage, determining, by the one or more processors, if there is a second music preference of the user that is trending; and
responsive to determining the second music preference of the user is trending, dynamically associating, by the one or more processors, the second music preference of the user that is trending with the advertisement.

7. The computer-implemented method of claim 1, further comprising:
responsive to determining it is more likely the user will engage with the potential advertisement if the potential advertisement is placed in the background section of the media item, loading, by the one or more processors, a set of time intervals associated with the trough region of the media item;
selecting, by the one or more processors, the advertisement;
determining, by the one or more processors, whether a level of engagement by the user with the potential advertisement exceeds the threshold when a narrator of the potential advertisement is selected;
responsive to determining the level of engagement by the user with the potential advertisement exceeds the threshold when the narrator of the potential advertisement is selected, dynamically selecting, by the one or more processors, the narrator of the advertisement based on the event of the media item to produce an updated advertisement;
determining, by the one or more processors, whether the level of engagement by the user with the potential advertisement exceeds the threshold when a volume of the potential advertisement is tuned;
responsive to determining the level of engagement by the user with the potential advertisement exceeds the threshold when the volume of the potential advertisement is tuned, dynamically tuning, by the one or more processors, the volume of the advertisement based on the event of the media item to produce an updated advertisement; and
presenting, by the one or more processors, the updated advertisement in the media item to the user.

8. The computer-implemented method of claim 7, further comprising:
responsive to determining the level of engagement by the user with the potential advertisement does not exceed the threshold when the narrator of the advertisement is selected, determining, by the one or more processors, whether the level of engagement by the user with the potential advertisement exceeds the threshold when the volume of the potential advertisement is tuned;
responsive to determining the level of engagement by the user with the potential advertisement does not exceed the threshold when the volume of the potential advertisement is tuned, playing, by the one or more processors, the original version of the advertisement.

9. The computer-implemented method of claim 7, wherein dynamically selecting the narrator of the advertisement based on the event of the media item to produce an updated advertisement further comprises:
assigning, by the one or more processors, a degree of matching between each version of the narrator of the advertisement and each trough region of the one or more trough regions of the media item;
responsive to determining there is not a threshold degree of matching between a first version of the narrator of the advertisement and a first trough region of the one or more trough regions of the media item, filtering, by the one or more processors, out the first version of the narrator of the advertisement; and
selecting, by the one or more processors, a version of the narrator of the advertisement with a highest degree of matching using a Fast Fourier transform.

10. The computer-implemented method of claim 1, further comprising:
subsequent to presenting the updated advertisement in the media item to the user, determining, by the one or more processors, whether the advertisement is within a maximum allowable time;
responsive to determining the advertisement is not within the maximum allowable time, determining, by the one or more processors, whether there are one or more other advertisements available; and
responsive to determining there are no other advertisements available, gathering, by the one or more processors, a set of data points on a set of parameters to optimize a future updated advertisement.

11. A computer program product comprising:
one or more computer readable storage media and program instructions stored on the one or more computer readable storage media, the program instructions comprising:
program instructions to determine whether a user is engaging with a media item on a platform by measuring one or more user engagement factors;
responsive to determining the user is not engaging with the media item, program instructions to analyze the media item to identify an event, wherein the event is a place where a potential advertisement may be inserted in the media item to maximize user engagement, wherein the event includes at least one of a peak region and a trough region, and wherein the peak region is an area with maximum user engagement and is referred to as a foreground section of the media item and the trough region is an area with minimal user engagement and is referred to as a background section of the media item;
program instructions to gather one or more metrics about the user to determine whether it is more likely the user engages with the potential advertisement if the potential advertisement is placed in the foreground section of the media item or the background section of the media item;
responsive to determining it is more likely the user will engage with the potential advertisement if the potential advertisement is placed in the foreground section of the media item, program instructions to load a set of time intervals associated with the peak region of the media item;
program instructions to select an advertisement to be placed in the media item;
program instructions to associate the advertisement with the media item;
program instructions to dynamically change a background music of the advertisement based on the event of the media item to produce an updated advertisement; and
program instructions to present the updated advertisement in the media item to the user.

12. The computer program product of claim 11, wherein dynamically changing the background music of the advertisement based on the event of the media item to produce the updated advertisement further comprises:
program instructions to determine whether there is music that can be associated with a first section of the two or more sections of the media item;
responsive to determining there is no music that can be associated with the first section of the two or more sections of the media item, program instructions to determine whether there is music that can be associated with the advertisement in the media item;
responsive to determining there is no music that can be associated with the advertisement in the media item, program instructions to determine if there is a first music preference of the user with which the user is more likely to engage;
responsive to determining there is no first music preference of the user with which the user is more likely to engage, program instructions to determine if there is a second music preference of the user that is trending; and
responsive to determining the second music preference of the user is trending, program instructions to dynamically associate the second music preference of the user that is trending with the advertisement.

13. The computer program product of claim 11, further comprising:
responsive to determining it is more likely the user will engage with the potential advertisement if the potential advertisement is placed in the background section of the media item, program instructions to load a set of time intervals associated with the trough region of the media item;
program instructions to select the advertisement;
program instructions to determine whether a level of engagement by the user with the potential advertisement exceeds the threshold when a narrator of the potential advertisement is selected;
responsive to determining the level of engagement by the user with the potential advertisement exceeds the threshold when the narrator of the potential advertisement is selected, program instructions to dynamically select the narrator of the advertisement based on the event of the media item to produce an updated advertisement;
program instructions to determine whether the level of engagement by the user with the potential advertisement exceeds the threshold when a volume of the potential advertisement is tuned;
responsive to determining the level of engagement by the user with the potential advertisement exceeds the threshold when the volume of the potential advertisement is tuned, program instructions to dynamically tune the volume of the advertisement based on the event of the media item to produce an updated advertisement; and
program instructions to present the updated advertisement in the media item to the user.

14. The computer program product of claim 13, wherein dynamically selecting the narrator of the advertisement based on the event of the media item to produce an updated advertisement further comprises:
program instructions to assign a degree of matching between each version of the narrator of the advertisement and each trough region of the one or more trough regions of the media item;
responsive to determining there is not a threshold degree of matching between a first version of the narrator of the advertisement and a first trough region of the one or more trough regions of the media item, program instructions to filter out the first version of the narrator of the advertisement; and
program instructions to select a version of the narrator of the advertisement with a highest degree of matching using a Fast Fourier transform.

15. The computer program product of claim 11, further comprising:
subsequent to presenting the updated advertisement in the media item to the user, program instructions to determine whether the advertisement is within a maximum allowable time;
responsive to determining the advertisement is not within the maximum allowable time, program instructions to determine whether there are one or more other advertisements available; and
responsive to determining there are no other advertisements available, program instructions to gather a set of data points on a set of parameters to optimize a future updated advertisement.

16. A computer system comprising:
one or more computer processors;
one or more computer readable storage media;
program instructions collectively stored on the one or more computer readable storage media for execution by at least one of the one or more computer processors, the stored program instructions comprising:
program instructions to determine whether a user is engaging with a media item on a platform by measuring one or more user engagement factors;
responsive to determining the user is not engaging with the media item, program instructions to analyze the media item to identify an event, wherein the event is a place where a potential advertisement may be inserted in the media item to maximize user engagement, wherein the event includes at least one of a peak region and a trough region, and wherein the peak region is an area with maximum user engagement and is referred to as a foreground section of the media item and the trough region is an area with minimal user engagement and is referred to as a background section of the media item;
program instructions to gather one or more metrics about the user to determine whether it is more likely the user engages with the potential advertisement if the potential advertisement is placed in the foreground section of the media item or the background section of the media item;
responsive to determining it is more likely the user will engage with the potential advertisement if the potential advertisement is placed in the foreground section of the media item, program instructions to load a set of time intervals associated with the peak region of the media item;
program instructions to select an advertisement to be placed in the media item;
program instructions to associate the advertisement with the media item;
program instructions to dynamically change a background music of the advertisement based on the event of the media item to produce an updated advertisement; and
program instructions to present the updated advertisement in the media item to the user.

17. The computer system of claim 16, wherein dynamically changing the background music of the advertisement based on the event of the media item to produce the updated advertisement further comprises:
program instructions to determine whether there is music that can be associated with a first section of the two or more sections of the media item;
responsive to determining there is no music that can be associated with the first section of the two or more sections of the media item, program instructions to determine whether there is music that can be associated with the advertisement in the media item;
responsive to determining there is no music that can be associated with the advertisement in the media item, program instructions to determine if there is a first music preference of the user with which the user is more likely to engage;
responsive to determining there is no first music preference of the user with which the user is more likely to engage, program instructions to determine if there is a second music preference of the user that is trending; and
responsive to determining the second music preference of the user is trending, program instructions to dynamically associate the second music preference of the user that is trending with the advertisement.

18. The computer system of claim 16, further comprising:
responsive to determining it is more likely the user will engage with the potential advertisement if the potential advertisement is placed in the background section of the media item, program instructions to load a set of time intervals associated with the trough region of the media item;
program instructions to select the advertisement;
program instructions to determine whether a level of engagement by the user with the potential advertisement exceeds the threshold when a narrator of the potential advertisement is selected;
responsive to determining the level of engagement by the user with the potential advertisement exceeds the threshold when the narrator of the potential advertisement is selected, program instructions to dynamically select the narrator of the advertisement based on the event of the media item to produce an updated advertisement;
program instructions to determine whether the level of engagement by the user with the potential advertisement exceeds the threshold when a volume of the potential advertisement is tuned;
responsive to determining the level of engagement by the user with the potential advertisement exceeds the threshold when the volume of the potential advertisement is tuned, program instructions to dynamically tune the volume of the advertisement based on the event of the media item to produce an updated advertisement; and
program instructions to present the updated advertisement in the media item to the user.

19. The computer system of claim 18, wherein dynamically selecting the narrator of the advertisement based on the event of the media item to produce an updated advertisement further comprises:
program instructions to assign a degree of matching between each version of the narrator of the advertisement and each trough region of the one or more trough regions of the media item;
responsive to determining there is not a threshold degree of matching between a first version of the narrator of the advertisement and a first trough region of the one or more trough regions of the media item, program instructions to filter out the first version of the narrator of the advertisement; and
program instructions to select a version of the narrator of the advertisement with a highest degree of matching using a Fast Fourier transform.

20. The computer system of claim 16, further comprising:
subsequent to presenting the updated advertisement in the media item to the user, program instructions to determine whether the advertisement is within a maximum allowable time;
responsive to determining the advertisement is not within the maximum allowable time, program instructions to determine whether there are one or more other advertisements available; and
responsive to determining there are no other advertisements available, program instructions to gather a set of data points on a set of parameters to optimize a future updated advertisement.

21. The computer-implemented method of claim 1, wherein the one or more user engagement factors includes at least one of an engagement with the media item, a viewership duration of the media item, a listenership duration of the media item, a viewership count of the media item, and a listenership of the media item, and wherein the engagement with the media item includes at least one of a selection of a skip option on the media item, a selection of a pause option on the media item, and a selection of a refresh option on the media item.
